(19) United States
(12) Patent Application Publication
(10) Pub. No.: US 2026/0274174 A1
(43) Pub. Date: Sep. 17, 2026

(54) MOUNTING BASE, DISPLAY DEVICE, AND VEHICLE

(71) Applicant: BOE TECHNOLOGY GROUP CO., LTD., Beijing (CN)

(72) Inventors: Yue Cui, Beijing (CN); Yue Lei, Beijing (CN); Yuanjie Li, Beijing (CN); Tao Wang, Beijing (CN); Lijuan Zhao, Beijing (CN); Hong Zhu, Beijing (CN)

(73) Assignee: BOE TECHNOLOGY GROUP CO., LTD., Beijing (CN)

(21) Appl. No.: 19/479,883

(22) PCT Filed: Feb. 8, 2025
(86) PCT No.: PCT/CN2025/076476

§ 371 Date: Oct. 29, 2025

(30) Foreign Application Priority Data
Mar. 13, 2024 (CN) 202410288795.4

(51) Int. Cl. B60R 11/02; B60R 11/00

(52) U.S. Cl. CPC B60R 11/0229; B60R 2011/0082

(57) ABSTRACT

Provided are a mounting base, a display device and a vehicle. The mounting base includes: a mounting frame including a connecting portion, a first fixing portion and a second fixing portion, the first fixing portion and the second fixing portion are respectively connected to two sides of the connecting portion, the first fixing portion and the second fixing portion are arranged at an included angle; a moving assembly slidably connected to at least one of the first fixing portion and second fixing portion, such that the moving assembly overlaps with or be staggered with at least one of the first fixing portion and second fixing portion; and a driving assembly in transmission connection with the moving assembly.

### CROSS-REFERENCE TO RELATED APPLICATION(S)

This application is a Section 371 National Stage Application of International Application No. PCT/CN 2025/076476 filed on Feb. 8, 2025, which claims priority to Chinese Patent Application No. 202410288795.4, filed on Mar. 13, 2024, the contents of which are incorporated herein by reference in their entireties.

### TECHNICAL FIELD

The present disclosure relates to the field of retraction apparatus technologies, and in particular to a mounting base, a display device and a vehicle.

### BACKGROUND

When a certain product is used in a space, due to limitations and constraints of the space, in order to meet more usage requirements, the product needs to have a retracting effect, such that the product is unfolded for use when the product needs to be used, and the product is retracted to avoid occupying space when the product does not need to be used.

In the related art, a difficulty of retracting the product increases as a size of the product becomes larger.

### SUMMARY

The present disclosure is intended to solve the technical problem of large retracting difficulty of some products in the related art to a certain extent. To this end, a mounting base, a display device and a vehicle are provided by the present disclosure.

The technical solutions of the present disclosure are as follows:
In a first aspect, a mounting base is provided by embodiments of the present disclosure, including: a mounting frame including a connecting portion, a first fixing portion and a second fixing portion, the first fixing portion and the second fixing portion are respectively connected to two sides of the connecting portion, and the first fixing portion and the second fixing portion are arranged at an included angle;
a moving assembly slidably connected to at least one of the first fixing portion and the second fixing portion, such that the moving assembly overlaps with at least one of the first fixing portion and the second fixing portion or being staggered with at least one of the first fixing portion and the second fixing portion; and a driving module in transmission connection with the moving assembly.
In a second aspect, a display device is provided by embodiments of the present disclosure, including: a mounting frame including a connecting portion, a first fixing portion and a second fixing portion, the first fixing portion and the second fixing portion are respectively connected to two sides of the connecting portion, and the first fixing portion and the second fixing portion are arranged at an included angle; a moving assembly slidably connected to at least one of the first fixing portion and the second fixing portion; a display module mounted on the moving assembly; and a driving assembly in transmission connection with the moving assembly, the driving assembly is configured to drive the display module to move relative to the first fixing portion and the second fixing portion through the moving assembly, such that the display module is in an unfolded state or a retracted state.
In a third aspect, a vehicle is provided by embodiments of the present disclosure, including: a vehicle body, and the above-mentioned the mounting base and/or the display device. The vehicle body includes a passenger compartment, and the mounting base and/or the display device are mounted in the passenger compartment.

### BRIEF DESCRIPTION OF THE DRAWINGS

In order to more clearly illustrate the technical solutions in embodiments of the present disclosure, the accompanying drawings used in the descriptions of embodiments will be briefly introduced below. It is apparent that the accompanying drawings in the following descriptions are only some embodiments of the present disclosure, and other drawings may be obtained by those of ordinary skill in the art according to these drawings without creative labor.

FIG. 1 shows a structural schematic diagram of a display module in a retracted state, of a display device according to one or more embodiments of the present disclosure;

FIG. 2 shows a structural schematic diagram of a display module in an unfolded state, of a display device in FIG. 1;

FIG. 3 shows a side view of a display device in FIG. 1;

FIG. 4 shows a side view of a display device in FIG. 2;

FIG. 5 shows a structural schematic diagram of a display device in FIG. 1 from another perspective;

FIG. 6 shows a structural schematic diagram of a display device in FIG. 2 from another perspective;

FIG. 7 shows an enlarged view of a part A in FIG. 1; and

FIG. 8 shows a schematic diagram of a stacked structure of a display module in FIG. 1.

### REFERENCE SIGNS

10—Display device, 20—Mounting base, 100—Mounting frame, 110—Connecting portion, 111—First side edge, 112—Third side edge, 120—First fixing portion, 121—First sliding rod, 130—Second fixing portion, 131—Third sliding rod, 140—Supporting portion, 200—Moving assembly, 210—First sliding member, 211—First sliding portion, 211a—First sliding groove, 211b—Second sliding groove, 212—Second sliding portion, 212a—Connecting rod, 212b—Second sliding rod, 212c—Second side edge, 220—Second sliding member, 221—Third sliding groove, 230—Connecting member, 231—Tension rope, 232—Tension pulley, 232a—Roller, 232b—Pulley seat, 300—Display module, 310—Cover plate layer, 320—Display layer, 330—Support layer, 340—First adhesive layer, 350—Buffer layer, 360—Second adhesive layer, 370—Hard layer, 380—Anti-reflection and anti-glare layer, 400—Driving assembly, 500—Roller shaft.

### DETAILED DESCRIPTION OF EMBODIMENTS

Technical solutions in embodiments of the present disclosure will be described clearly and completely below with reference to the accompanying drawings. It is obvious that the embodiments described are only some embodiments of the present disclosure, rather than all embodiments. All other embodiments, which may be derived by those of ordinary skill in the art from embodiments in the present disclosure without creative labor, fall within the protection scope of the present disclosure.

In addition, the present disclosure may repeat reference numbers and/or reference letters in different examples. Such repetition is for the purpose of simplicity and clarity, and the repetition itself does not indicate a relationship between various embodiments and/or settings discussed. In addition, the present disclosure provides examples of various specific processes and materials, but those of ordinary skill in the art may recognize the application of other processes and/or the use of other materials.

When a certain product in a space, due to limitations and constraints of the space, in order to meet more usage requirements, the product needs to have a retracting effect, such that the product is unfolded for use when the product needs to be used, and the product is retracted to avoid occupying space when the product does not need to be used.

In the related art, a difficulty of retracting the product increases as a size of the product becomes larger.

To this end, embodiments of the present disclosure provide a mounting base 20, a display device 10 and a vehicle, which may improve the above-mentioned problems. The mounting base 20 provided by embodiments of the present disclosure may reduce a retracting difficulty of a product by enabling the product mounted on the mounting base 20 to be unfolded and retracted in different directions.

The present disclosure will be described below with reference to the drawings and specific embodiments.

Referring to FIG. 1 to FIG. 8, embodiments of the present disclosure provide a mounting base 20 used to mount products such as a display module 300, a sun visor, a table board, etc., and may realize unfolding and retracting of the above-mentioned products, such that when the product needs to be used, the product is unfolded through the mounting base 20, and when the product does not need to be used, the product is retracted through the mounting base 20 to avoid occupying space. At the same time, the unfolding and retracting of the mounting base 20 are in different directions, such that the unfolding and retracting of the product mounted on the mounting base 20 may be in different directions, so as to reduce the retracting difficulty of the product.

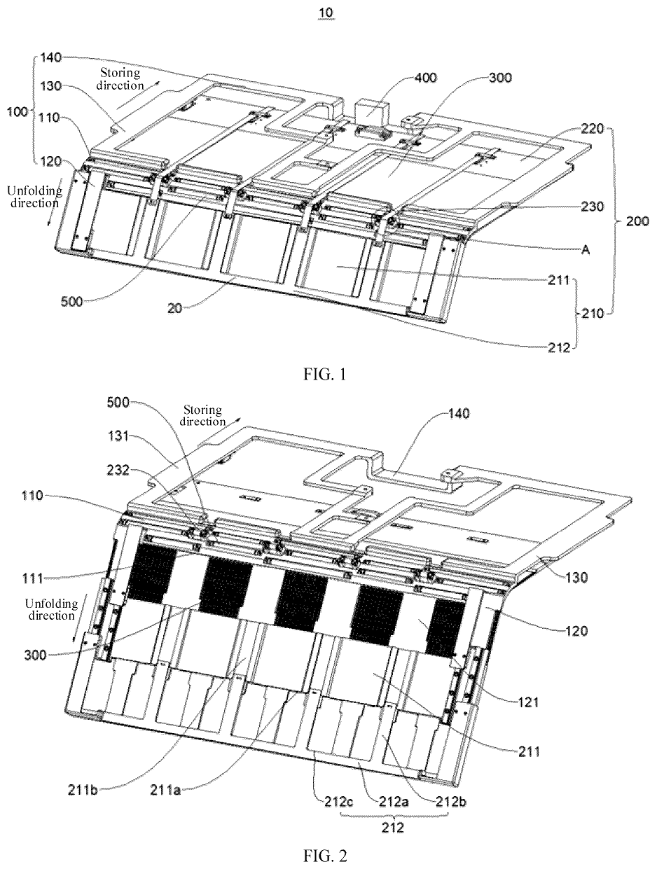

As shown in FIG. 1 and FIG. 2, the mounting base 20 includes a mounting frame 100, a moving assembly 200 and a driving assembly 400. In some embodiments, the mounting frame 100 includes a connecting portion 110, a first fixing portion 120 and a second fixing portion 130. The first fixing portion 120 and the second fixing portion 130 are respectively connected to two sides of the connecting portion 110, and the first fixing portion 120 and the second fixing portion 130 are arranged at an included angle. The moving assembly 200 is slidably connected to at least one of the first fixing portion 120 and the second fixing portion 130, such that the moving assembly 200 may overlap with or be staggered with at least one of the first fixing portion 120 and the second fixing portion 130. The driving assembly 400 is in transmission connection with the moving assembly 200.

In some embodiments, the mounting frame 100 provides a mounting foundation for the moving assembly 200 and the driving assembly 400, and the mounting frame 100 includes the connecting portion 110, the first fixing portion 120 and the second fixing portion 130. The connecting portion 110 provides a mounting foundation for the first fixing portion 120 and the second fixing portion 130, and the first fixing portion 120 and the second fixing portion 130 are respectively connected to two sides of the connecting portion 110.

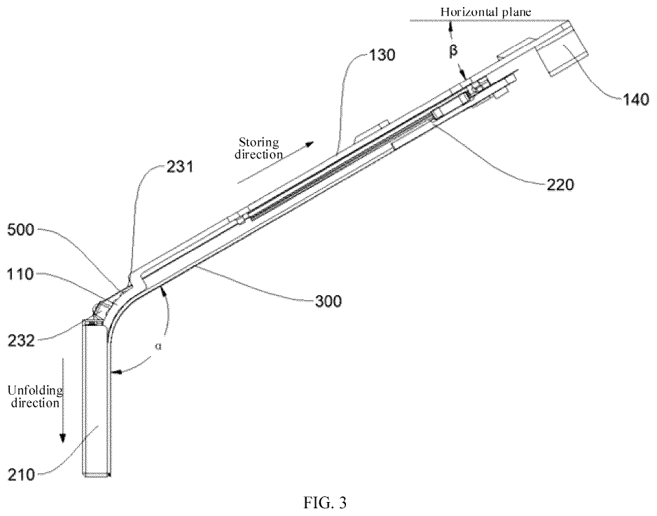

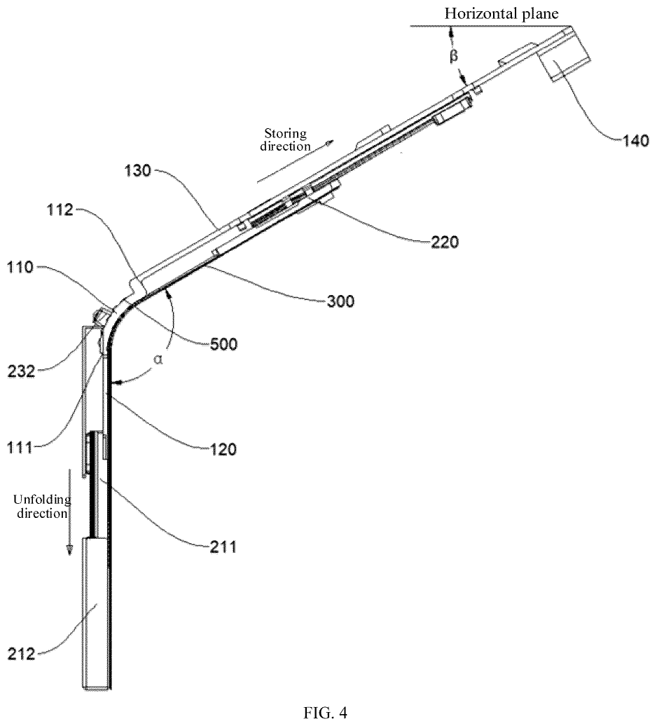

As shown in FIG. 3 and FIG. 4, the first fixing portion 120 and the second fixing portion 130 are respectively located on two sides of the connecting portion 110, and the first fixing portion 120 and the second fixing portion 130 are arranged at an included angle. That is, the first fixing portion 120 and the second fixing portion 130 are arranged in different directions. In some embodiments, an orientation of the first fixing portion 120 is a direction of the first fixing portion 120 away from the connecting portion 110, and an orientation of the second fixing portion 130 is a direction of the second fixing portion 130 away from the connecting portion 110.

The moving assembly 200 is slidably connected to at least one of the first fixing portion 120 and the second fixing portion 130, such that the moving assembly 200 may overlap with or be staggered with at least one of the first fixing portion 120 and the second fixing portion 130.

In some embodiments, the moving assembly 200 overlapping with at least one of the first fixing portion 120 and the second fixing portion 130 means that when the moving assembly 200 slides in a direction close to the first fixing portion 120 or the second fixing portion 130, the moving assembly 200 may stack with the first fixing portion 120 or the second fixing portion 130, and an projection of the moving assembly 200 in a direction perpendicular to a movement direction of the moving assembly 200 is located on the first fixing portion 120 or the second fixing portion 130, so as to reduce a volume of retracting the moving assembly 200 on the first fixing portion 120 or the second fixing portion 130 and reduce a space occupation.

The moving assembly 200 staggering with at least one of the first fixing portion 120 and the second fixing portion 130 means that when the moving assembly 200 slides in a direction away from the first fixing portion 120 or the second fixing portion 130, the moving assembly 200 will be unfolded and arranged side by side relative to the first fixing portion 120 or the second fixing portion 130, so as to ensure a maximum unfolding volume of the moving assembly 200 on the first fixing portion 120 or the second fixing portion 130.

That is, the moving assembly 200 may be slidably connected to the first fixing portion 120, such that in a process of the moving assembly 200 sliding relative to the first fixing portion 120, the retracting and unfolding of the moving assembly 200 in an arrangement direction of the first fixing portion 120 are realized through overlapping or staggering of the moving assembly 200 with the first fixing portion 120; the moving assembly 200 may also be slidably connected to the second fixing portion 130, such that in a process of the moving assembly 200 sliding relative to the second fixing portion 130, the retracting and unfolding of the moving assembly 200 in an arrangement direction of the second fixing portion 130 are realized through overlapping or staggering of the moving assembly 200 with the second fixing portion 130; the moving assembly 200 may also be connected to both the first fixing portion 120 and the second fixing portion 130 simultaneously, such that in a process of the moving assembly 200 sliding relative to the first fixing portion 120 and the second fixing portion 130, the retracting and unfolding of the moving assembly 200 in the arrangement direction of the first fixing portion 120 and the arrangement direction of the second fixing portion 130 may be realized through overlapping or staggering of the moving assembly 200 with the first fixing portion 120 and the second fixing portion 130.

The driving assembly 400 is in transmission connection with the moving assembly 200. The driving assembly 400 is used to drive the moving assembly 200 to move, enabling the moving assembly 200 to slide relative to the mounting frame 100. The product is mounted on the moving assembly 200, and the product is driven to move by a movement of the moving assembly 200, and the product moves along the first fixing portion 120 and the second fixing portion 130.

For example, for ease of description, embodiments of the present disclosure will be describe taking a display module 300 as the product. A movement direction the display module 300 away from the connecting portion 110 on the first fixing portion 120 is taken as an unfolding direction, and a movement direction of the display module 300 away from the connecting portion 110 on the second fixing portion 130 is taken as a retracting direction. In an unfolded state, the display module 300 is almost entirely moved from the second fixing portion 130 to the first fixing portion 120; in a retracted state, the display module 300 is almost entirely moved from the first fixing portion 120 to the second fixing portion 130. The first fixing portion 120 and the second fixing portion 130 are arranged at an included angle, such that the display module 300 may be unfolded and retracted in different directions. This enables unfolding and retracting in different directions, ensuring a display size in the unfolded state while reducing the space occupation in the retracted state and lowering the retracting difficulty.

In summary, in the mounting base 20 provided by embodiments of the present disclosure, since the moving assembly 200 may be driven by the driving assembly 400 to move relative to the first fixing portion 120 and the second fixing portion 130, by mounting the product on the moving assembly 200, the product may be driven by the moving assembly 200 to move along the first fixing portion 120 and the second fixing portion 130. Meanwhile, the first fixing portion 120 and the second fixing portion 130 on the mounting frame 100 are arranged at an included angle, such that the product mounted on the mounting base 20 may be unfolded and retracted in different directions, thereby reducing the space occupation and lowering the retracting difficulty.

In some embodiments, as shown in FIG. 3, the included angle between the first fixing portion 120 and the second fixing portion 130 is greater than 60 degrees.

As shown in FIG. 3, the included angle between the first fixing portion 120 and the second fixing portion 130 is a first included angle α. Since the first fixing portion 120 and the second fixing portion 130 are arranged at an angle, and the product mounted on the mounting base 20 may move along the first fixing portion 120 and the second fixing portion 130, unfolding and retracting directions of the product may be determined by the first included angle α.

Therefore, in order to ensure a movement effect of the product on the mounting frame 100, the first included angle α is set to be greater than 60 degrees, enabling better unfolding and retracting of the product.

In some embodiments, the first included angle α may be 70 degrees, 80 degrees, 90 degrees, 100 degrees, 110 degrees, 120 degrees, 130 degrees, etc., which is not limited by embodiments of the present disclosure.

In some embodiments, as shown in FIG. 1 and FIG. 2, the moving assembly 200 includes a first sliding member 210, a second sliding member 220, and a connecting member 230. The first sliding member 210 is slidably connected to the first fixing portion 120, the second sliding member 220 is slidably connected to the second fixing portion 130, the connecting member 230 connects the first sliding member 210 with the second sliding member 220, and the driving assembly 400 is in transmission connection with the first fixing portion 120, the second fixing portion 130, or the connecting member 230.

The first sliding member 210 is slidably connected to the first fixing portion 120, and the second sliding member 220 is slidably connected to the second fixing portion 130. Thus, in a case that the first fixing portion 120 and the second fixing portion 130 are arranged at an angle, a sliding direction of the first sliding member 210 and a sliding direction of the second sliding member 220 are also arranged at an angle.

Furthermore, a direction of the product moving away from the connecting portion 110 along the first fixing portion 120 under a driving of the moving assembly 200 is taken as an unfolding direction, and a direction of the product moving away from the connecting portion 110 along the second fixing portion 130 under a driving of the moving assembly 200 is taken as a retracting direction. Then, a direction of the first sliding member 120 away from the connecting portion 110 is the unfolding direction, and a direction of the second sliding member 220 away from the connecting portion 110 is the retracting direction.

The product is mounted on the first sliding member 210 and the second sliding member 220, such that the product, the first sliding member 210 and the second sliding member 220 are connected as a whole. Through sliding of the first sliding member 210 and the second sliding member 220 relative to the first fixing portion 120 and the second fixing portion 130, the product may move along the first fixing portion 120 and the second fixing portion 130, such that the unfolding direction and the retracting direction of the product are in different directions.

In addition, the moving assembly 200 further includes a connecting member 230. The connecting member 230 connects the first sliding member 210 with the second sliding member 220, such that the first fixing portion 120, the second fixing portion 130, and the connecting member 230 are connected as a whole, enabling the first fixing portion 120 and the second fixing portion 130 to move synchronously, ensuring a stability of the product during unfolding and retracting. For example, in a case that the product is the display module 300, wrinkling, folding, etc. of the display module 300 during unfolding and retracting may be avoided.

Since the first fixing portion 120, the second fixing portion 130, and the connecting member 230 are connected as a whole, the driving assembly 400 may be in transmission connection with the first fixing portion 120, the second fixing portion 130, or the connecting member 230, that is, the driving assembly 400 may drive at least one of the first fixing portion 120, the second fixing portion 130 and the connecting member 230 to drive the product to move.

In some embodiments, as shown in FIG. 2 and FIG. 4, the first sliding member 210 includes a first sliding portion 211 and a second sliding portion 212 that are slidably connected in sequence, and the first sliding portion 211 is slidably connected to the first fixing portion 120.

A direction of the product moving away from the connecting portion 110 along the first fixing portion 120 is taken as an unfolding direction, and a direction of the product moving away from the connecting portion 110 along the second fixing portion 130 is taken as a retracting direction. Therefore, the first fixing portion 120 and the first sliding member 210 need to ensure the retracting effect of the product while ensuring the unfolding effect of the product, so as to avoid the first fixing portion 120 and the first sliding member 210 occupying too much space in the retracted state. Thus, the first sliding member 210 may be set to include the first sliding portion 211 and the second sliding portion 212 that are slidably connected in sequence, the first sliding portion 211 is slidably connected to the first fixing portion 120, and the product is fixedly connected to the second sliding portion 212. In the unfolded state, the first sliding portion 211, the second sliding portion 212, and the first fixing portion 120 are unfolded and arranged side by side, which ensures a maximum unfolding volume of the product. In the retracted state, the first sliding portion 211, the second sliding portion 212, and the first fixing portion 120 overlap with each other, which reduces a retracting volume of the first fixing portion 120 and the first sliding member 210.

In addition, more than two first sliding portions 211 that are slidably connected in sequence may be arranged between the second sliding portion 212 and the first fixing portion 120, which is not limited by embodiments of the present disclosure.

In some embodiments, as shown in FIG. 2, the first sliding portion 211 has a plurality of first sliding grooves 211a arranged at intervals. The first fixing portion 120 includes a plurality of first sliding rods 121 arranged at intervals on the connecting portion 110. The first sliding rod 121 is mounted in the first sliding groove 211a and may slide relative to the first sliding groove 211a.

In order to realize a sliding connection between the first sliding portion 211 and the first fixing portion 120, the first sliding groove 211a is provided on the first sliding portion 211, and the first sliding rod 121 is provided on the first fixing portion 120. The first sliding rod 121 is mounted in the first sliding groove 211a, and the sliding connection between the first sliding portion 211 and the first fixing portion 120 is realized through sliding of the first sliding rod 121 relative to the first sliding groove 211a.

A plurality of first sliding grooves 211a are provided on the first sliding portion 211 and are arranged at intervals, and a plurality of first sliding rods 121 are provided on the first fixing portion 120 and are arranged at intervals, such that the plurality of first sliding grooves 211a are in one-to-one corresponding sliding connection with the plurality of first sliding rods 121. This improves a support performance of the first sliding portion 211, such that the first sliding portion 211 serving as an unfolding portion of the product may provide additional support for the product.

It should be noted that the number of the first sliding rods 121 affects the support performance of the first sliding rods 121 and a friction force between the first sliding rods 121 and the first sliding grooves 211a. The more the number of the first sliding rods 121, the better the support performance and the greater the friction force; conversely, the fewer the number of the first sliding rods 121, the worse the support performance and the less the friction force.

In some embodiments, the first sliding rod 121 is connected to a first side edge 111 of the connecting portion 110, and a sum of lengths of joints of all the first sliding rods 121 and the first side edge 111 is in a range of 40% to 60% of a length of the first side edge 111.

The first side edge 111 of the connecting portion 110 is arranged toward the first sliding member 210, such that the first sliding rods 121 are slidably connected to the first sliding grooves 211a of the first sliding portion 211 by arranging the plurality of first sliding rods 121 at intervals on the first side edge 111 of the connecting portion 110. Providing the plurality of first sliding rods 121 may increase a support for the product, and the number of the first sliding rods 121 also affects the friction force between the first sliding rods 121 and the first sliding grooves 211a. Therefore, the sum of the lengths of the joints of all the first sliding rods 121 and the first side edge 111 is set to be 40% to 60% of the length of the first side edge 111. This ensures the support performance of the first sliding rods 121 for the product, while avoiding excessive friction force between the first sliding rods 121 and the first sliding grooves 211a, and ensuring a sliding effect of the first sliding rods 121 and the first sliding grooves 211a.

In some embodiments, the sum of the lengths of the joints of all the first sliding rods 121 and the first side edge 111 may be 40%, 45%, 50%, 55%, 60%, etc., of the length of the first side edge 111, which is not limited by embodiments of the present disclosure. It should be understood that a region enclosed by the connecting portion 110, the first fixing portion 120, and the first sliding portion 211 is rectangular, the plurality of first sliding rods 121 are arranged at intervals in the rectangular region, and an area ratio of the plurality of first sliding rods 121 in the rectangular region is in a range of 40% to 60%.

In some embodiments, as shown in FIG. 2, the plurality of first sliding grooves 211a are alternately arranged on two opposite sides of the first sliding portion 211.

In order to further balance the support performance and the friction force of the first sliding rods 121, the plurality of first sliding grooves 211 a are alternately arranged on two opposite sides of the first sliding portion 211, that is, the plurality of first sliding rods 121 are alternately slidably connected to two opposite sides of the first sliding portion 211, thereby further improving the support performance of the first sliding rods 121 for the product.

In some embodiments, a length of the first sliding rod 121 is in a range of 30 mm to 50 mm, and a length of the first sliding groove 211a is in a range of 30 mm to 50 mm.

In order to achieve the technical effect of balancing the support performance and the friction force of the first sliding rod 121, a size of the first sliding rod 121 is limited, and the length of the first sliding rod 121 is limited to be in a range of 30 mm to 50 mm. For example, the length of the first sliding rod 121 may be 30 mm, 35 mm, 40 mm, 45 mm, 50 mm, etc. Correspondingly, the length of the first sliding groove 211a is also limited to be in a range of 30 mm to 50 mm, and the length of the first sliding groove 211a may be 30 mm, 35 mm, 40 mm, 45 mm, 50 mm, etc.

It should be noted that the length of the first sliding rod 121 and the length of the first sliding groove 211a refer to sizes of the first sliding rod 121 and the first sliding groove 211a in the sliding direction of the first sliding member 210.

In some embodiments, as shown in FIG. 2, the first sliding portion 211 has a plurality of second sliding grooves 211b arranged at intervals. The second sliding portion 212 includes a connecting rod 212a and a plurality of second sliding rods 212b. The plurality of second sliding rods 212b are arranged at intervals on the connecting rod 212a. The second sliding rod 212b is mounted in the second sliding groove 211b and may slide relative to the second sliding groove 211b, and the connecting member 230 is connected to the connecting rod 212a or the second sliding rod 212b.

In order to realize a sliding connection between the first sliding portion 211 and the second sliding portion 212, the second sliding groove 211b is provided on the first sliding portion 211, and the second sliding portion 212 includes the connecting rod 212a and the second sliding rod 212b. The second sliding rod 212b is mounted in the second sliding groove 211b, and the sliding connection between the second sliding portion 212 and the first sliding portion 211 is realized through sliding of the second sliding rod 212b relative to the second sliding groove 211b.

A plurality of second sliding grooves 211b are provided on the first sliding portion 211 and are arranged at intervals, and a plurality of second sliding rods 212b are provided on the connecting rod 212a of the second sliding portion 212 and are arranged at intervals, and the plurality of second sliding grooves 211b are in one-to-one corresponding sliding connection with the plurality of second sliding rods 212b. This may improve a support performance of the second sliding portion 212, such that the second sliding portion 212 serving as an unfolding portion of the product may provide additional support for the product.

Since the connecting member 230 is connected to the second sliding portion 212, and the second sliding portion 212 includes the connecting rod 212a and the second sliding rod 212b that are connected, the connecting member 230 may be connected to the connecting rod 212a, and the connecting member 230 may also be connected to the second sliding rod 212b, which is not limited by embodiments of the present disclosure.

It should be noted that the number of the second sliding rods 212b affects the support performance of the second sliding rods 212b and a friction force between the second sliding rods 212b and the second sliding grooves 211b. The more the number of the second sliding rods 212b, the better the support performance and the greater the friction force; conversely, the fewer the number of the second sliding rods 212b, the worse the support performance and the less the friction force.

In some embodiments, the second sliding rod 212b is connected to a second side edge 212c of the connecting rod 212a, and a sum of lengths of joints of all the second sliding rods 212b and the second side edge 212c is in a range of 40% to 60% of a length of the second side edge 212c.

The second side edge 212c of the connecting rod 212a of the second sliding portion 212 is arranged toward the first sliding member 210, such that the second sliding rods 212b are slidably connected to the second sliding grooves 211b of the first sliding portion 211 by arranging the plurality of second sliding rods 212b at intervals on the second side edge 212c of the connecting rod 212a. Providing the plurality of second sliding rods 212b may increase the support for the product, and the number of the second sliding rods 212b also affects the friction force between the second sliding rods 212b and the second sliding grooves 211b. Therefore, the sum of the lengths of the joints of all the second sliding rods 212b and the second side edge 212c is set to be 40% to 60% of the length of the second side edge 212c. This ensures the support performance of the second sliding rods 212b for the product, avoids excessive friction force between the second sliding rods 212b and the second sliding grooves 211b, and ensures a sliding effect of the second sliding rods 212b and the second sliding grooves 211b.

In some embodiments, the sum of the lengths of the joints of all the second sliding rods 212b and the second side edge 212c may be 40%, 45%, 50%, 55%, 60%, etc., of the length of the second side edge 212c, which is not limited by embodiments of the present disclosure. It should be understood that, a region enclosed by the second sliding portion 212 and the first sliding portion 211 is rectangular, the plurality of second sliding rods 212b are arranged at intervals in the rectangular region, and an area ratio of the plurality of second sliding rods 212b in the rectangular region is in a range of 40% to 60%.

In addition, in order to ensure a connection stability among the first fixing portion 120, the first sliding portion 211, and the second sliding portion 212, the plurality of first sliding grooves 211a and the plurality of second sliding grooves 211b on the first sliding portion 211 are alternately arranged.

In some embodiments, as shown in FIG. 2, the plurality of second sliding grooves 211b are alternately arranged on two opposite sides of the first sliding portion 211.

In order to further balance the support performance and the friction force of the second sliding rods 212b, the plurality of second sliding grooves 211b are alternately arranged on two opposite sides of the first sliding portion 211, that is, the plurality of second sliding rods 212b are alternately slidably connected to two opposite sides of the first sliding portion 211, thereby further improving the support performance of the second sliding rods 212b for the product.

In some embodiments, a width of the connecting rod 212a is in a range of 2 mm to 8 mm, a length of the second sliding rod 212b is in a range of 30 mm to 50 mm, and a length of the second sliding groove 211b is in a range of 30 mm to 50 mm.

The connecting rod 212a is used for connection with the product. By setting the width of the connecting rod 212a to be in range of 2 mm to 8 mm, a connection effect between the connecting rod 212a and the product is ensured. In some embodiments, the width of the connecting rod 212a may be 2 mm, 3 mm, 4 mm, 5 mm, 6 mm, 7 mm, 8 mm, etc., which is not limited by embodiments of the present disclosure.

In order to achieve the technical effect of balancing the support performance and the friction force of the second sliding rods 212b, a size of the second sliding portion 212 needs to be limited, and the length of the second sliding rod 212b is limited to be in a range of 30 mm to 50 mm. For example, the length of the second sliding rod 212b may be 30 mm, 35 mm, 40 mm, 45 mm, 50 mm, etc. Correspondingly, the length of the second sliding groove 211b is also limited to be in a range of 30 mm to 50 mm, and the length of the second sliding groove 211b may be 30 mm, 35 mm, 40 mm, 45 mm, 50 mm, etc.

It should be noted that the width of the connecting rod 212a, the length of the second sliding rod 212b, and the length of the second sliding groove 211b refer to sizes of the connecting rod 212a, the second sliding rod 212b, and the second sliding groove 211b in the sliding direction of the first sliding member 210.

In some embodiments, as shown in FIG. 2, one of the first sliding member 210 and the first fixing portion 120 is provided with the first sliding groove 211a, the other is provided with the first sliding rod 121, the first sliding rod 121 is mounted in the first sliding groove 211a and may slide relative to the first sliding groove 211a.

A sliding connection between the first sliding member 210 and the first fixing portion 120 may be realized through the sliding connection between the sliding groove and the sliding rod. The first sliding groove 211a is provided on the first sliding member 210, and the first sliding rod 121 is provided on the first fixing portion 120; or the first sliding rod 121 is provided on the first sliding member 210, and the first sliding groove 211a is provided on the first fixing portion 120. The first sliding rod 121 is mounted in the first sliding groove 211a, and the sliding connection between the first sliding member 210 and the first fixing portion 120 is realized through the sliding of the first sliding rod 121 relative to the first sliding groove 211a.

In some embodiments, as shown in FIG. 2, one of the second sliding member 220 and the second fixing portion 130 is provided with a third sliding groove 221, and the other is provided with a third sliding rod 131, and the third sliding rod 131 is mounted in the third sliding groove 221 and may slide relative to the third sliding groove 221.

A sliding connection between the second sliding member 220 and the second fixing portion 130, may be realized through the sliding connection between the sliding groove and the sliding rod. The third sliding groove 221 is provided on the second sliding member 220, and the third sliding rod 131 is provided on the second fixing portion 130; or the third sliding rod 131 is provided on the second sliding member 220, and the third sliding groove 221 is provided on the second fixing portion 130. The third sliding rod 131 is mounted in the third sliding groove 221, and the sliding connection between the second sliding member 220 and the second fixing portion 130 is realized through the sliding of the third sliding rod 131 relative to the third sliding groove 221.

In some embodiments, as shown in FIG. 2, the second sliding member 220 is provided with the third sliding groove 221, the second fixing portion 130 includes the third sliding rod 131, the third sliding rod 131 is connected to a third side edge 112 of the connecting portion 110, and the third sliding rod 131 is mounted in the third sliding groove 221 and may slide relative to the third sliding groove 221.

The third side edge 112 of the connecting portion 110 is arranged toward the second sliding member 220. By arranging the third sliding rod 131 on the third side edge 112 of the connecting portion 110, the third sliding rod 131 is slidably connected to the third sliding groove 221 of the second sliding member 220.

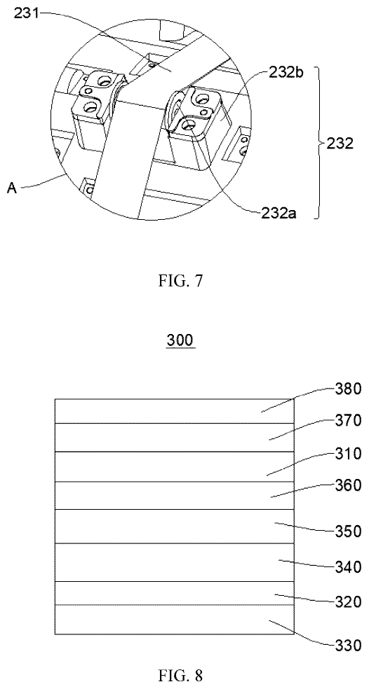

In some embodiments, as shown in FIG. 1 and FIG. 7, the connecting member 230 includes a tension rope 231 and at least one tension pulley 232, two ends of the tension rope 231 are respectively connected to the first sliding member 210 and the second sliding member 220, and the tension rope 231 is wound around the tension pulley 232.

The connecting member 230 is used to connect the first sliding member 210 with the second sliding member 220, so as to connect the first sliding member 210 and the second sliding member 220 as a whole. The connecting member 230 is set to include the tension rope 231 to connect the first sliding member 210 and the second sliding member 220 as a whole by respectively connecting two ends of the tension rope 231 to the first sliding member 210 and the second sliding member 220. In order to ensure a tension of the tension rope 231, the connecting member 230 is set to further include a tension pulley 232, and the tension rope 231 is wound around the tension pulley 232.

Furthermore, in order to ensure a stability of a tension connection of the connecting member 230, a plurality of tension ropes 231 may be arranged at intervals. Meanwhile, in order to ensure a tension effect of the tension pulley 232 on the tension rope 231, a plurality of tension pulleys 232 may be provided for each tension rope 231.

In addition, when the first sliding member 210 is provided as the first sliding portion 211 and the second sliding portion 212 which are slidably connected, the second sliding portion 212 is connected to the tension rope 231.

In some embodiments, as shown in FIG. 1 and FIG. 7, the tension pulley 232 is mounted on the connecting portion 110.

In order to realize an arrangement of the tension pulley 232 on the mounting base 20, the tension pulley 232 is mounted on the connecting portion 110. That is, the connecting member 230 and the product are respectively arranged on two opposite sides of the mounting frame 100, the connecting portion 110 is arranged between the tension pulley 232 and the product, two ends of the tension rope 231 are respectively connected to two ends of the first sliding member 210 and the second sliding member 220, and both the first sliding member 210 and the second sliding member 220 are arranged between the tension rope 231 and the product.

In some embodiments, as shown in FIG. 7, the tension pulley 232 includes a roller 232a and a pulley seat 232b, the pulley seat 232b is mounted on the connecting portion 110, the roller 232a is rotatably mounted on the pulley seat 232b, the tension rope 231 is wound around the roller 232a, and the tension rope 231 is in rolling connection with the roller 232a, so as to realize a mounting arrangement of the tension pulley 232 on the connecting portion 110.

In some embodiments, the mounting frame 100 further includes a supporting portion 140 connected to an end of the second fixing portion 130 away from the connecting portion 110. The driving assembly 400 includes a motor, a screw rod, and a nut, the motor is arranged on the supporting portion 140, the screw rod is connected to an output shaft of the motor, the nut is arranged on the second sliding member 220, and the nut is screwed with the screw rod.

The screw is driven by the motor to rotate, and under a rotation of the screw rod, the nut moves in an axial direction of the screw rod. Since the nut is connected to the second sliding member 220, the second sliding member 220 may be driven to move in the axial direction of the screw rod, and the axial direction of the screw rod is the sliding direction of the second sliding member 220 on the second fixing portion 130.

In addition, the nut may also be arranged on the supporting portion 140, and the motor is arranged on the second sliding member 220, which may also realize the driving of the second sliding member 220 by the driving assembly 400, which is not limited by embodiments of the present disclosure.

In summary, the mounting base 20 provided by embodiments of the present disclosure may enable the product mounted on the mounting base 20 to be unfolded and retracted in different directions. When the product is switched from the retracted state to the unfolded state, the motor drives the second sliding member 220 to slide in a direction close to the connecting portion 110, and the first sliding member 210 slides in a direction away from the connecting portion 110 under a combined action of the product and the connecting member 230 until the first sliding portion 211 and the second sliding portion 212 of the first sliding member 210 are completely unfolded, and the product is in the unfolded state at this time. When the product is switched from the unfolded state to the retracted state, the motor drives the second sliding member 220 to slide in a direction away from the connecting portion 110, and the first sliding member 210 slides in a direction close to the connecting portion 110 under the combined action of the product and the connecting member 230 until the first sliding portion 211 and the second sliding portion 212 of the first sliding member 210 are completely folded, and the product is in the retracted state at this time. Since the first fixing portion 120 and the second fixing portion 130 are arranged at an included angle, the sliding direction of the first sliding member 210 and the sliding direction of the second sliding member 220 form an included angle, such that the product may be unfolded and retracted in different directions, thereby reducing the space occupation and lowering the retracting difficulty.

Based on a same inventive concept, embodiments of the present disclosure also propose a display device 10. The display device 10 may display internet information, audio-visual entertainment information, etc., and thus has a wide range of applications. In order to meet more usage requirements, when the display device 10 is used in some spaces, due to space limitations and constraints, the display device 10 needs to have a retracting effect. That is, when the display device 10 needs to be used, the display device 10 is unfolded for use; when the display device 10 does not need to be used, the display device 10 is retracted to avoid occupying space.

In the related art, the display device 10 may be unfolded and retracted in a foldable manner, a telescopic manner, etc. In some embodiments, a foldable display device 10 needs to be flipped during unfolding and retracting of the display device 10, thus requiring a sufficient flipping area in the space. ; a telescopic display device 10 needs to be moved in a same direction as a whole during unfolding and retracting, that is, the unfolding and retracting of the display device 10 are in the same direction. In addition, the telescopic retracting display device 10 needs to be provided with a separate retracting space, and a retracting space and an unfolding space of the display device 10 need to have a same extension direction, thus increasing a difficulty of configuring the retracting space. Therefore, the current display device 10 has high retracting difficulty. Especially as the size of the display device 10 becomes larger and larger, the retracting difficulty of the display device 10 also increases.

To this end, embodiments of the present disclosure provide a display device 10. The display device 10 provided by embodiments of the present disclosure may reduce the retracting difficulty of the display device 10 by arranging unfolding and retracting of a display module 300 in different directions.

As shown in FIG. 1 and FIG. 2, the display device 10 includes a display module 300 and the above-mentioned mounting base 20, the display module 300 is mounted on the moving assembly 200, and the driving assembly 400 may drive the display module 300 to move relative to the first fixing portion 120 and the second fixing portion 130 through the moving assembly 200, such that the display module 300 may be in an unfolded state or a retracted state.

In some embodiments, the driving assembly 400 is in transmission connection with the moving assembly 200, and the driving assembly 400 is used to drive the moving assembly 200 to move, such that the moving assembly 200 slides relative to the mounting frame 100, so as to drive the display module 300 to move through the movement of the moving assembly 200.

The moving assembly 200 drives the display module 300 to move relative to the first fixing portion 120 and the second fixing portion 130. That is, when the display module 300 slides relative to the first fixing portion 120 and the second fixing portion 130, the display module 300 may slide along the first fixing portion 120 and the second fixing portion 130 at the same time.

For example, when the display device 10 is mounted in a vehicle, the display device 10 is arranged in a passenger compartment of the vehicle. The second fixing portion 130 may be attached to a top portion, a side portion, a bottom portion, or the like of the passenger compartment. Since the first fixing portion 120 and the second fixing portion 130 are arranged at an included angle, the first fixing portion 120 may extend into the passenger compartment at a certain angle. In some embodiments, for the convenience of description, a moving direction of the display module 300 away from the connecting portion 110 on the first fixing portion 120 is defined as an unfolding direction, and a moving direction of the display module 300 away from the connecting portion 110 on the second fixing portion 130 is defined as a retracting direction.

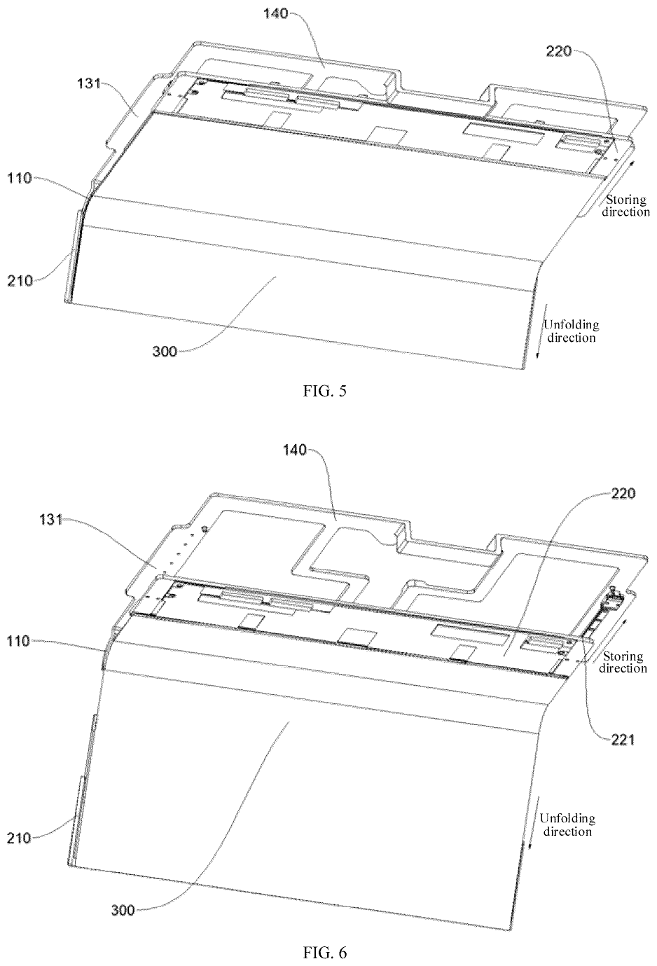

As shown in FIG. 5 and FIG. 6, when the display module 300 needs to be unfolded, the driving assembly 400 drives the display module 300 to unfold along the first fixing portion 120 through the moving assembly 200, such that the display module 300 almost entirely slides onto the first fixing portion 120, enabling the display module 300 to be unfolded inside the passenger compartment. When the display module 300 needs to be retracted, the driving assembly 400 drives the display module 300 to be retracted in a direction of the second fixing portion 130 away from the connecting portion 110 through the moving assembly 200, such that the display module 300 is attached to the top portion, the side portion, the bottom portion or the like of the passenger compartment for retraction.

In a case that the display device 10 is mounted on the top portion of the passenger compartment, when the display module 300 is in the unfolded state, a display region of the display module 300 is located on the first fixing portion 120, such that the display module 300 may be arranged downward, vertically downward or obliquely downward. When the display module 300 is in the retracted state, the display module 300 is almost located on the second fixing portion 130, such that the display module 300 may be retracted to the top portion of the passenger compartment. The same logic applies when the display device 10 is mounted in other positions of the passenger compartment, which will not be described in detail here.

Thus, the display module 300 may be unfolded and retracted in different directions. The display device 10 may be unfolded inside the passenger compartment to meet use needs of a passenger inside the passenger compartment. At the same time, when the display device 10 does not need to be used, the display module 300 may be retracted to the top portion, the side portion, the bottom portion or the like of the passenger compartment, thereby reducing the space occupation inside the passenger compartment of the vehicle and lowering the retracting difficulty of the display device 10.

In summary, in the display device 10 provided by embodiments of the present disclosure, the display module 300 is mounted on the moving assembly 200. The driving assembly 400 drives the moving assembly 200 to move relative to the first fixing portion 120 and the second fixing portion 130, and the moving assembly 200 drives the display module 300 to move relative to the first fixing portion 120 and the second fixing portion 130. Meanwhile, through an included angle arrangement of the first fixing portion 120 and the second fixing portion 130 on the mounting frame 100, the display module 300 may be unfolded and retracted in different directions, thereby reducing the space occupation and lowering the retracting difficulty.

In some embodiments, as shown in FIG. 3, the display module 300 is mounted on the mounting base 20. In order to ensure a viewing effect of the user, the first included angle α is set to be greater than 60 degrees, such that a display surface of the unfolded display module 300 may better face the user, providing a good viewing effect for the user. In addition, in order to avoid excessive folding of the display module 300 which may affect a sliding effect of the display module 300 on the mounting frame 100, the first included angle α is set to be greater than 60 degrees, such that the display module 300 may be better unfolded and retracted.

For example, as shown in FIG. 3, an included angle between the top portion of the passenger compartment and a horizontal plane is a second included angle β. When the display module 300 is mounted in the vehicle, the second fixing portion 130 is attached to the top portion of the passenger compartment, and the first fixing portion 120 extends into the interior of the passenger compartment. Under a condition that the second included angle β is 30 degrees, by setting the first included angle α to 120 degrees, the display surface of the unfolded display module 300 may face the passenger in the passenger compartment.

In some embodiments, as shown in FIG. 3 and FIG. 4, the retracting direction and the unfolding direction of the display module 300 are arranged at an included angle.

In order to further reduce the retracting difficulty of the display device 10, the retracting direction and the unfolding direction of the display module 300 are set to have an included angle, that is, the retracting direction and the unfolding direction of the display module 300 are in different directions. For example, a direction in which the moving assembly 200 drives the display module 300 to move away from the connecting portion 110 along the first fixing portion 120 is the unfolding direction, and correspondingly, a direction in which the moving assembly 200 drives the display module 300 to move away from the connecting portion 110 along the second fixing portion 130 is the retracting direction.

The way of unfolding and retracting the display module 300 determines the space occupation of the display device 10. Setting the retracting direction and the unfolding direction of the display module 300 at an included angle may reduce the space occupation of the display module 300 during unfolding and retracting. The closer the included angle between the retracting direction and the unfolding direction of the display module 300 is to the included angle between the first fixing portion 120 and the second fixing portion 130, the more closely the display module 300 is attached to the mounting frame 100 during movement, and the less space the display module 300 occupies during unfolding and retracting.

In some embodiments, when the display module 300 is in the unfolded state, the display region of the display module 300 is located on at least one of the first fixing portion 120 and the moving assembly 200; when the display module 300 is in the retracted state, the display region is at least partially located on the second fixing portion 130.

In some embodiments, the display region of the display module 300 is located on at least one of the first fixing portion 120 and the moving assembly 200. The display region of the display module 300 may be located on the first fixing portion 120, or located on the moving assembly 200, or located on both the first fixing portion 120 and the moving assembly 200, so as to realize the unfolding of the display module 300.

The display region of the display module 300 is at least partially located on the second fixing portion 130, that is, the display region may be entirely located on the second fixing portion 130, or mostly located on the second fixing portion 130, both of which may be regarded as the retracting of the display module 300.

The display region of the display module 300 is an image display region of the display module 300. In terms of space occupation, it is mainly a part of the display module 300 in the display region that occupies the space. That is, the unfolding and retracting of the display module 300 mainly refer to the unfolding and retracting of the display region of the display module 300.

During the switching of the display module 300 from the retracted state to the unfolded state, the driving assembly 400 drives the display module 300 to slide in a direction of the first fixing portion 120 away from the connecting portion 110 through the moving assembly 200, such that the display module 300 is unfolded, and the display region of the display module 300 is located on at least one of the first fixing portion 120 and the moving assembly 200.

During the switching of the display module 300 from the unfolded state to the retracted state, the driving assembly 400 drives the display module 300 to be retracted in a direction of the second fixing portion 130 away from the connecting portion 110 through the moving assembly 200, such that the display region of the display module 300 is at least partially located on the second fixing portion 130, thus realizing the retracting of the display module 300.

For example, when the display device 10 is mounted in the vehicle, the display module 300 is arranged in the passenger compartment of the vehicle. The second fixing portion 130 is attached to the top portion, the side portion, the bottom portion or the like of the passenger compartment, and the first fixing portion 120 extends into the interior of the passenger compartment. The moving direction of the display module 300 away from the connecting portion 110 on the first fixing portion 120 is the unfolding direction, and the moving direction of the display module 300 away from the connecting portion 110 on the second fixing portion 130 is the retracting direction.

When the display module 300 is in the unfolded state, the part of the display module 300 in the display region is unfolded inside the passenger compartment to realize the unfolding of the display module 300. When the display module 300 is in the retracted state, the part of the display module 300 in the display region is at least partially retracted to the top portion, the side portion, the bottom portion or the like of the passenger compartment to realize the retracting of the display module 300. It should be understood that in order to ensure the retracting effect of the display device 10, in the retracted state, the part of the display module 300 in the display region is almost entirely retracted to the top portion, the side portion, the bottom portion or the like of the passenger compartment.

In some embodiments, as shown in FIG. 2 and FIG. 4, two ends of the display module 300 are respectively connected to the first sliding member 210 and the second sliding member 220.

The display region of the display module 300 is located between two ends of the display module 300. The two ends of the display module 300 are respectively connected to the first sliding member 210 and the second sliding member 220, the direction of the first sliding member 120 away from the connecting portion 110 is the unfolding direction, and the direction of the second sliding member 220 away from the connecting portion 110 is the retracting direction.

When the display module 300 is switched from the retracted state to the unfolded state, an end of the display module 300 connected to the first sliding member 210 is moved and unfolded along with the first sliding member 210 in a direction away from the connecting portion 110, and the other end of the display module 300 connected to the second sliding member 220 is moved along with the second sliding member 220 in a direction close to the connecting portion 110, and at this time, the display region of the display module 300 is completely located in the unfolding direction. When the display module 300 is switched from the unfolded state to the retracted state, the end of the display module 300 connected to the first sliding member 210 is moved and retracted along with the first sliding member 210 in a direction close to the connecting portion 110, and the other end of the display module 300 connected to the second sliding member 220 is moved along with the second sliding member 220 in a direction away from the connecting portion 110. At this time, the display region of the display module 300 is at least partially located in the retracting direction.

In some embodiments, as shown in FIG. 1 and FIG. 7, the tension pulley 232 is arranged at an interval from the display module 300.

In order to prevent the tension rope 231 from contacting the display module 300 and causing wear to the display module 300, the tension pulley 232 is arranged at an interval from the display module 300, such that the tension rope 231 is arranged at an interval from the display module 300 through the tension pulley 232.

In some embodiments, as shown in FIG. 8, the display module 300 includes a cover plate layer 310, a display layer 320 and a support layer 330 stacked in sequence. The support layer 330 is connected to the moving assembly 200, and a modulus of the support layer 330 is in a range of 1 Gpa to 10 Gpa.

In the unfolded and retracted states of the display module 300, the display module 300 needs to realize an overall movement and an angle change simultaneously, such that the display module 300 may be attached to the mounting frame 100 during sliding on the mounting frame 100. Therefore, the display module 300 needs to have both rigidity and flexibility. Thus, the display module 300 is set to include the cover plate layer 310, the display layer 320 and the support layer 330 stacked in sequence. In some embodiments, the support layer 330 determines the rigidity and flexibility of the display module 300. Therefore, the modulus of the support layer 330 is set to be in a range of 1 Gpa to 10 Gpa, such that the display module 300 has both rigidity and flexibility, so as to realize the overall movement and the angle change simultaneously during the unfolding and retracting. The modulus of the support layer 330 may be 1 Gpa, 2 Gpa, 3 Gpa, 4 Gpa, 5 Gpa, 6 Gpa, 7 Gpa, 8 Gpa, 9 Gpa, 10 Gpa, etc.

The support layer 330 is connected to the moving assembly 200, and the support layer 330 is further used to realize a mounting connection between the display module 300 and the moving assembly 200, such that a back of the display surface of the display module 300 is connected to the moving assembly 200, that is, the mounting frame 100 is located on the back of the display surface of the display module 300, and the support layer 330 of the display module 300 is attached to the mounting frame 100.

In some embodiments, as shown in FIG. 8, the display module 300 further includes a first adhesive layer 340, a buffer layer 350, a second adhesive layer 360, a hard layer 370 and an anti-reflection and anti-glare layer 380. The support layer 330, the display layer 320, the first adhesive layer 340, the buffer layer 350, the second adhesive layer 360, the cover plate layer 310, the hard layer 370 and the anti-reflection and anti-glare layer 380 are stacked in sequence to form an overall structure of the display module 300.

In some embodiments, as shown in FIG. 1, the display device 10 further includes a roller shaft 500 rotatably embedded in the connecting portion 110, and the display module 300 is in rolling connection with the roller shaft 500.

The roller shaft 500 may be used to guide the display module 300. A part of the display module 300 corresponding to the connecting portion 110 is in rolling connection with the roller shaft 500, and parts of the display module 300 corresponding to the first fixing portion 120 and the second fixing portion 130 are respectively located on two sides of the roller shaft 500. Thereby, the display module 300 is guided by the roller shaft 500 during the sliding of the display module 300 relative to the first fixing portion 120 and the second fixing portion 130.

In addition, since the display module 300 is in rolling connection with the roller shaft 500, the part of the display module 300 corresponding to the connecting portion 110 does not contact the connecting portion 110, avoiding wear of the display module 300 caused by the connecting portion 110.

A plurality of roller shafts 500 may be provided. On one hand, the plurality of roller shafts 500 are arranged at intervals in the moving direction of the display module 300; on the other hand, the plurality of roller shafts 500 are arranged at intervals in a direction perpendicular to the moving direction of the display module 300, so as to improve a guiding effect of the roller shafts 500 on the display module 300 and reduce wear of the display module 300.

In summary, the display module 300 of the display device 10 provided by embodiments of the present disclosure may be unfolded and retracted in different directions. When the display module 300 is switched from the retracted state to the unfolded state, the motor drives the second sliding member 220 to slide in a direction close to the connecting portion 110. Under the combined action of the display module 300 and the connecting member 230, the first sliding member 210 slides in a direction away from the connecting portion 110 until the first sliding portion 211 and the second sliding portion 212 of the first sliding member 210 are completely unfolded, and the display module 300 is in the unfolded state at this time. When the display module 300 is switched from the unfolded state to the retracted state, the motor drives the second sliding member 220 to slide in a direction away from the connecting portion 110. Under the combined action of the display module 300 and the connecting member 230, the first sliding member 210 slides in a direction close to the connecting portion 110 until the first sliding portion 211 and the second sliding portion 212 of the first sliding member 210 are completely retracted, and the display module 300 is in the retracted state at this time. Since the first fixing portion 120 and the second fixing portion 130 are arranged at an included angle, the sliding direction of the first sliding member 210 and the sliding direction of the second sliding member 220 form an included angle, such that the display module 300 may be unfolded and retracted in different directions, thereby reducing the space occupation and lowering the retracting difficulty.

Based on a same inventive concept, embodiments of the present disclosure also propose a vehicle, the vehicle includes a vehicle body and the above-mentioned mounting base 20 and/or the above-mentioned display device 10. Since the vehicle is equipped with the above-mentioned mounting base 20 and/or the above-mentioned display device 10, the vehicle has at least all the beneficial effects brought by the technical solutions of the above-mentioned display device 10.

The vehicle body of the vehicle has a passenger compartment, and the mounting base 20 and/or the display device 10 are mounted in the passenger compartment for use by the passenger in the passenger compartment. When the product and/or the display device 10 mounted on the mounting base 20 need to be unfolded, the product and/or the display module 300 mounted on the mounting base 20 are unfolded from a part (the top portion, the side portion, the bottom portion, or the like) in the passenger compartment that may reduce the space occupation in the passenger compartment to the inside of the passenger compartment; when the product and/or the display device 10 mounted on the mounting base 20 need to be retracted, the product and/or the display module 300 mounted on the mounting base 20 are retracted from the inside of the passenger compartment to the part in the passenger compartment that may reduce the space occupation in the passenger compartment. Thus, the retracting effect of the display device 10 is realized.

In some embodiments, a mounting cavity is provided in the passenger compartment, and the mounting frame 100 is mounted in the mounting cavity. When the display module 300 is in the unfolded state, the display region is located outside the mounting cavity; and when the display module 300 is in the retracted state, the display region is at least partially located in the mounting cavity.

The mounting cavity and the passenger compartment have different extending directions. The mounting cavity is used to mount the display device 10 and realize the retracting of the display module 300, mainly for unfolding and retracting the display region of the display module 300. The retracting direction of the display device 10 is the same as the extending direction of the mounting cavity. That is, when the display module 300 is in the unfolded state, the display region of the display module 300 is located outside the mounting cavity; when the display module 300 is in the retracted state, the display region of the display module 300 is at least partially located in the mounting cavity. In order to realize the arrangement of the display device 10 in the mounting cavity, the mounting frame 100 is typically fixedly connected to a cavity wall of the mounting cavity.

In some embodiments, the mounting base 20 or the display device 10 is mounted to the top portion of the passenger compartment, and the first fixing portion 120 is located below the second fixing portion 130.

The unfolding of the mounting base 20 or the display module 300 along the first fixing portion 120 is taken as the unfolded state of the mounting base 20 or the display module 300, and the retracting of the mounting base 20 or the display module 300 along the second fixing portion 130 is taken as the retracted state of the mounting base 20 or the display module 300. By mounting the mounting base 20 or the display device 10 to the top portion of the passenger compartment, the first fixing portion 120 is located below the second fixing portion 130. Thus, the unfolding direction of the mounting base 20 or the display device 10 is a direction from the top portion of the passenger compartment to the bottom portion of the passenger compartment. The second fixing portion 130 is attached to the top portion of the passenger compartment to reduce the space occupation in the passenger compartment in the retracted state. When the product or the display device 10 mounted on the mounting base 20 needs to be used, the mounting base 20 or the display device 10 is unfolded downward from the top portion of the passenger compartment; when the product or the display device 10 mounted on the mounting base 20 does not need to be used, the mounting base 20 or the display device 10 is retracted upward to the top portion of the passenger compartment.

In summary, the mounting base 20 or the display device 10 is mounted in the mounting cavity at the top portion of the passenger compartment, the mounting cavity is communicated with the inside of the passenger compartment, and the mounting cavity and the passenger compartment have different extending directions, the mounting cavity is arranged along the extending direction of the top portion of the passenger compartment. Meanwhile, the retracting direction of the mounting base 20 or the display device 10 is the same as the retracting direction of the mounting cavity. When the passenger in the passenger compartment needs to use the product or the display device 10 mounted on the mounting base 20, the mounting base 20 or the display device 10 is switched from the retracted state to the unfolded state, and the product or the display module 300 mounted on the mounting base 20 is unfolded downward into the passenger compartment; when the passenger in the passenger compartment does not need to use the product or the display device 10 mounted on the mounting base 20, the mounting base 20 or the display device 10 is switched from the unfolded state to the retracted state, and the product or the display module 300 mounted on the mounting base 20 is retracted upward into the mounting cavity.

In the present disclosure, unless otherwise clearly specified and defined, a first feature being “on” or “under” a second feature may include the first feature and the second feature being in direct contact, or may include the first feature and the second feature not being in direct contact but being in contact through another feature between the first feature and the second feature. Moreover, the first feature being “on”, “above” and “over” the second feature includes the first feature being directly above and obliquely above the second feature, or simply means that the first feature is higher than the second feature. The first feature being “under”, “below” and “beneath” the second feature includes the first feature being directly below and obliquely below the second feature, or simply means that the first feature is lower than the second feature.

In the descriptions of the present disclosure, it should be understood that the directions or positional relationships indicated by the terms such as “central”, “longitudinal”, “transverse”, “length”, “width”, “thickness”, “upper”, “lower”,“front”, “rear”, “left”, “right”, “vertical”, “horizontal”, “top”, “bottom”, “inner”, “outer”, “clockwise”, and “counterclockwise” are based on the directions or positional relationships shown in the accompanying drawings, are merely for the convenience of describing the present disclosure and simplifying description, and do not indicate and imply that the apparatus or element referred to must have a particular orientation or be constructed and operated in a particular orientation, and therefore should not be construed as limiting the present disclosure.

It should be noted that all directional indications in embodiments of the present disclosure are only used to explain relative positional relationships, movement conditions, etc. of the components in a specific posture. If the specific posture changes, the directional indications will also change accordingly.

In the present disclosure, unless otherwise clearly specified and defined, the terms “connected”, “fixed” and the like should be understood in a broader sense. For example, “fixed” may mean a fixed connection, a detachable connection, or being integrally formed; “connected” may mean a mechanical connection or an electrical connection; “connected” may mean a direct connection or an indirect connection through an intermediate medium, and “connected” may mean an internal communication between two elements or an interaction relationship between two elements, unless otherwise clearly defined. For those of ordinary skill in the art, the specific meanings of the above-mentioned terms in the present disclosure may be understood according to specific situations.

In addition, in the present disclosure, descriptions involving “first”, “second” and the like are only used for descriptive purposes, and are not to be construed as indicating or implying relative importance or implicitly indicating the number of technical features indicated. Therefore, features defined with “first” and “second” may explicitly or implicitly include one or more of said features. In the descriptions of the present disclosure, “a plurality of” means two or more, unless otherwise clearly and specifically defined.

In the descriptions of the specification, a description with reference to the terms “an embodiment”, “some embodiments”, “examples”, “specific examples”, “some examples” or the like means that the specific features, structures, materials, or characteristics described in conjunction with the embodiment or example are included in at least one embodiment or example of the present disclosure. In the specification, schematic expressions of the above-mentioned terms are not necessarily directed to the same embodiments or examples. Moreover, the specific features, structures, materials, or characteristics described may be combined in any one or more embodiments or examples in an appropriate manner. In addition, those skilled in the art may incorporate and combine different embodiments or examples described in the specification.

In addition, the technical solutions of the various embodiments may be combined with each other, but must be achievable for those of ordinary skill in the art. When the combination of technical solutions is contradictory or cannot be realized, it should be considered that such a combination of technical solutions does not exist and is not within the protection scope of the present disclosure.

Although embodiments of the present disclosure have been shown and described, those of ordinary skill in the art may understand that various changes, modifications, substitutions and variations may be made to these embodiments without departing from the principle and spirit of the present disclosure, and the scope of the present disclosure is defined by the claims and their equivalents.

1. A mounting base, comprising:
a mounting frame comprising a connecting portion, a first fixing portion and a second fixing portion, wherein the first fixing portion and the second fixing portion are respectively connected to two sides of the connecting portion and the first fixing portion and the second fixing portion are arranged at an included angle;
a moving assembly slidably connected to at least one of the first fixing portion and the second fixing portion such that the moving assembly overlaps with at least one of the first fixing portion and the second fixing portion or being staggered with at least one of the first fixing portion and the second fixing portion; and
a driving assembly in transmission connection with the moving assembly.

2. The mounting base according to claim 1, wherein the included angle between the first fixing portion and the second fixing portion is greater than 60 degrees.

3. The mounting base according to claims 1, wherein the moving assembly comprises a first sliding member, a second sliding member and a connecting member, the first sliding member is slidably connected to the first fixing portion, the second sliding member is slidably connected to the second fixing portion, the connecting member is configured to connect the first sliding member with the second sliding member, and the driving assembly is in transmission connection with the first fixing portion, the second fixing portion or the connecting member.

4. The mounting base according to claim 3, wherein the first sliding member comprises a first sliding portion and a second sliding portion slidably connected in sequence, and the first sliding portion is slidably connected to the first fixing portion.

5. The mounting base according to claim 4, wherein the first sliding portion comprises a plurality of first sliding grooves arranged at intervals, the first fixing portion comprises a plurality of first sliding rods arranged at intervals on the connecting portion, and a first sliding rod of the plurality of first sliding rods is mounted in a first sliding groove of the plurality of first sliding groove and is slidable relative to the first sliding groove.

6. The mounting base according to claim 5, wherein the first sliding rod is connected to a first side edge of the connecting portion, and a sum of lengths of joints between all the first sliding rods and the first side edge is in a range of 40% to 60% of a length of the first side edge

7. The mounting base according to claim 5, wherein the plurality of first sliding grooves are alternately arranged on two opposite sides of the first sliding portion.

8. The mounting base according to claim 5, wherein a length of the first sliding portion is in a range of 30 mm to 50 mm, and a length of the first sliding groove is in a range of 30 mm to 50 mm.

9. The mounting base according to claim 4, wherein the first sliding portion comprises a plurality of second sliding grooves arranged at intervals, the second sliding portion comprises a connecting rod and a plurality of second sliding rods, the plurality of second sliding rods are arranged at intervals on the connecting rod, a second sliding rod of the plurality of second sliding rods is mounted in a second sliding groove of the plurality of second sliding grooves and is slidable relative to the second sliding groove, and the connecting member is connected to the connecting rod or the second sliding rod.

10. The mounting base according to claim 9, wherein the second sliding rod is connected to a second side edge of the connecting rod, and a sum of lengths of joints between all the second sliding rods and the second side edge is in a range of 40% to 60% of a length of the second side edge.

11. The mounting base according to claim 9, wherein the plurality of second sliding grooves are alternately arranged on two opposite sides of the first sliding portion.

12. The mounting base according to claim 9, wherein a width of the connecting rod is 2 mm to 8 mm, a length of the second sliding rod is 30 mm to 50 mm, and a length of the second sliding groove is 30 mm to 50 mm.

13. The mounting base according to claim 3, wherein,
one of the first sliding member and the first fixing portion comprises a first sliding groove, and the other of the first sliding member and the first fixing portion comprises a first sliding rod, and the first sliding rod is mounted in the first sliding groove and is slidable relative to the first sliding groove; and
the connecting member comprises a tension rope and at least one tension pulley, two ends of the tension rope are respectively connected to the first sliding member and the second sliding member, the tension rope is wound around a tension pulley of the at least one tension pulley, and the tension pulley is mounted on the connecting portion.

14. (canceled)

15. (canceled)

16. A display device, comprising:
a mounting frame comprising a connecting portion a first fixing portion and a second fixing portion wherein the first fixing portion and the second fixing portion are respectively connected to two sides of the connecting portion and the first fixing portion and the second fixing portion are arranged at an included angle;
a moving assembly slidably connected to at least one of the first fixing portion and the second fixing portion
a display module mounted on the moving assembly and
a driving assembly in transmission connection with the moving assembly wherein the driving assembly is configured to drive the display module to move relative to the first fixing portion and the second fixing portion through the moving assembly such that the display module is in an unfolded state or a retracted state.

17. The display device according to claim 16, wherein,
a retracting direction and an unfolding direction of the display module are arranged at an included angle;
in a case that the display module is in the unfolded state, a display region of the display module is located on at least one of the first fixing portion and the moving assembly; and in a case that the display module is in the retracted state, the display region of the display module is at least partially located on the second fixing portion.

18. (canceled)

19. The display device according to claims 16, wherein the moving assembly comprises a first sliding member, a second sliding member and a connecting member, the first sliding member is slidably connected to the first fixing portion, the second sliding member is slidably connected to the second fixing portion, the connecting member is configured to connect the first sliding member with the second sliding member the display module is mounted on the first sliding member and the second sliding member, and the driving assembly is in transmission connection with the first fixing portion, the second fixing portion or the connecting member.

20. The display device according to claim 19, wherein,
two ends of the display module are respectively connected to the first sliding member and the second sliding member; and
the connecting member comprises a tension rope and at least one tension pulley, two ends of the tension rope are respectively connected to the first sliding member and the second sliding member, the tension rope is wound around a tension pulley of the at least one tension pulley, and the tension pulley is arranged at an interval from the display module.

21. (canceled)

22. The display device according to claim 16, wherein,
the display module comprises a cover plate layer, a display layer and a support layer stacked in sequence, the support layer is connected to the moving assembly, and a modulus of the support layer is in a range of 1 Gpa to 10 Gpa; and
the display device further comprises a roller shaft rotatably embedded in the connecting portion, and the display module is in rolling connection with the roller shaft.

23. (canceled)

24. A vehicle, comprising: a vehicle body, and the display device according to claim 16, wherein the vehicle body comprises a passenger compartment, and the display device is mounted in the passenger compartment.

25. The vehicle according to claim 24, wherein,
a mounting cavity is provided in the passenger compartment, the mounting frame is mounted in the mounting cavity, in a case that the display module is in the unfolded state, the display region is located outside the mounting cavity; and in a case that the display module is in the retracted state, the display region is at least partially located in the mounting cavity; and
the mounting base or the display device is mounted on a top portion of the passenger compartment, and the first fixing portion is located below the second fixing portion.

26. (canceled)
